(19) United States
(12) Patent Application Publication
(10) Pub. No.: US 2006/0134269 A1
(43) Pub. Date: Jun. 22, 2006

(54) Method of preparing a ripening flora comprising a cell weakening step

(75) Inventors: Patrick Gervais, Quetigny (FR); Christian Thibaut, Dijon (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: BIOSAVEURS, Henri Becquerel (FR)

(21) Appl. No.: 10/515,177

(22) PCT Filed: May 20, 2003
(86) PCT No.: PCT/FR03/01516

§ 371 Date: Jul. 13, 2005

(30) Foreign Application Priority Data
May 27, 2002 (FR) 02/06433

(51) Int. Cl. A23C 9/12

(52) U.S. Cl. 426/42

(57) ABSTRACT

A content reception device includes a station selection switch. The station selection switch is operated to select a desired broadcast station from a plurality of broadcast stations that are broadcasting by streaming through a plurality of channels by shifting times little by little. When the station selection switch is operated to select a desired broadcast station from a plurality of broadcast stations, a channel is selected from a plurality of channels allocated to the currently-selected broadcast station according to the number of times a first selection switch and a second selection switch are operated. This allows the user to go back the time of the streaming broadcast and reverse the progress of the content in a pseudo mode or to advance the time and fast-forward the content in a pseudo mode.

The invention relates to a method for preparing a ripening flora involving a cell weakening step, and to the use of such a flora for and/or in the preparation of fermented products, in particular for cheese preparation.

There are two main steps in the methods for the manufacture of fermented products:

a first step of preparing the raw material for its subsequent fermentation,

a second, ripening step leading to the production of the finished product during which the constituents of the raw material, milk in the case of cheese, are converted by various means, such as physical, microbiological and enzymatic means and combinations thereof.

More specifically, the customary methods for the manufacture of fermented dairy products comprise, after standardization and if necessary thermization of the milk, the following steps:

coagulation or precipitation of the curd: this is obtained by adding enzymes (rennet) and/or by acidifying the raw material. At this stage of the method, and depending on the final product desired and the defined operating conditions, it is possible to use flora which is naturally present in the raw material used or to optionally add thereto an additional technological flora (lactic ferments, ripening microbial flora, termed secondary flora);

draining: it makes it possible to separate the whey from the coagulum so as to bring the latter to a defined water content and to adjust the mineralization thereof; at the beginning of this step, cutting and washing, stirring or pressing, washing and molding may be carried out according to the desired final product;

salting: it acts on the bound water by changing the bonds between the water and the substrate. Thus, it completes the draining, acts on the development of the microorganisms and consequently influences ripening and contributes to the taste of the cheese;

ripening: it corresponds to the enzymatic digestion of the curd obtained by biochemical conversions giving the cheese its novel characteristics: the enzymes used during this step are called ripening agents and may be of diverse origins (milk, rennet or substitute, microorganisms of the milk, starter cultures, atmosphere and the like).

This latter ripening step being quite long, it has been sought for a long time, for economic reasons, to reduce its duration. However, while a shorter ripening time is often obtained, it is always at the expense of the organoleptic properties of the products finally obtained.

There have already been proposed methods which make it possible to reduce the duration of the ripening phase while improving the organoleptic properties of the products obtained, in particular of the dairy products.

Thus, in patent application FR-A-2 761 237, there has been proposed a ripening method using a cellular extract of a complete bouquet of ripening microorganisms in order to reduce the duration of the ripening phase for fermented food products while improving the organoleptic properties. According to this application, there is added to the components of the raw material a cellular extract of a complete bouquet of ripening microorganisms whose composition and proportions are based overall on that of the natural or inoculated ripening flora.

The preparation of this cellular extract comprises the following steps:

preparation of the biomass, optionally followed by its concentration,

cellular lysis,

mixing of the extracts obtained.

The preparation of the cellular lysate makes it possible to recover the enzymes from the microorganisms of the bouquet before adding them to the curd.

However, it has been observed that after the cellular lysis, the water-soluble intracellular content of the microorganisms is released too rapidly and becomes lost in the whey.

It has moreover already been proposed to weaken lactic acid bacteria which are then used for ripening of the cheese in order to facilitate the release of the enzymes which they contain in order to reduce the duration of the ripening phase and to improve the organoleptic properties of the cheeses thus obtained.

Thus, for example, in the article by Fox P. F., Food Biotechnology, 1988-89, 2, 133-185, there are mentioned various techniques which make it possible to accelerate the cheese ripening phase, among which are mentioned weakening of lactic acid bacteria by the action of lysozyme, by heat shock or cold shock, by treating with a solvent or by neutralization. Moreover, the article by Madkor et al., Dairy Science, 2000, 83, 1684-1691 describes a method for preparing a Cheddar-type cheese in which the ripening phase is carried out by means of a mesophilic flora supplemented with lactic acid bacteria which are weakened by cold or heat treatment or by spray-drying. It is also possible, in the case of lactic acid bacteria, to weaken the bacteria by freeze-drying (Johnson J. A. C. et al., Journal of Dairy Science, 1995, 78(4), 769-776).

There has also been proposed, in particular in international application WO 01/30172, a method for preparing a cheese using a particular yeast Kluyveromyces lactis or an enzyme derived from such a yeast. This application states that the yeast may be optionally used in a weakened form, the weakening then being performed by treatment in a microwave oven.

While the various weakening techniques used to date are quite suitable for lactic acid bacteria, their application to other microorganisms, in particular to complete bouquets of microorganisms, does not always make it possible to avoid an excessively rapid release of the ripening enzymes into the whey and is not completely satisfactory, in particular as regards the final organoleptic properties of the products obtained.

The inventors consequently set themselves the aim of providing a novel method of cell weakening which is applicable to numerous ripening microorganisms, which makes it possible not only to solve the problem of an excessively rapid release of ripening enzymes into the whey and therefore the loss of the intracellular content of the ripening microorganisms, but also to reduce the duration of the ripening phase while further improving the final organoleptic properties of the products obtained.

A first subject of the present invention is therefore a method for manufacturing a fermented dairy product comprising a step of ripening by means of a suspension of ripening microorganisms in which the number of cells constituting said suspension is 10 to 10 000 times as high as that of the same microorganism naturally present in the starting raw material to be ripened, characterized in that it comprises, before bringing said suspension into contact with the raw material, at least one preliminary step of cell weakening of said microorganisms by means of an osmotic shock or a high-pressure shock.

The inventors have indeed observed that such a weakening step is sufficiently gentle to avoid premature solubilization of the intracellular content, and consequently the excessively premature release of the ripening enzymes and their subsequent loss in the whey, as has been observed in the cell lysis step of the method for preparing the bouquet of ripening microorganisms of the prior art.

This weakening step is nevertheless quite extensive to allow release of the ripening enzymes after coagulation of the milk and the formation of the curd.

According to an advantageous embodiment of the method in accordance with the invention, the microorganism(s) constituting the suspension used are chosen from:

Gram-positive bacteria among which there may be mentioned in particular:

the Corynebacteriaceae family:
Genus Corynebacterium, and in particular C. glutamicum,
Genus Brevibacterium, and in particular B. linens,
Genus Arthrobacter, and in particular A. globiformis,
Genus Propionobacterium,
the Micrococaceae family:
Genus Micrococcus,
Genus Staphylococcus, and in particular S. xilosus and S. carnosus,

Gram-negative bacteria among which there may be mentioned in particular:

the Enterobacteriaceae family:

1 Genus Hafnia, and in particular H. alvei,
Genus Enterococcus, and in particular E. faecalis and E faecium.

The yeasts among which there may be mentioned in particular:

Genus Debaryomyces, and in particular D. hansenii,

Genus Saccharomyces, and in particular S. cerevisiae,

Genus Kluyveromyces, and in particular K. lactis,

Genus Geotrichum, and in particular G. candidum.

Molds among which there may be mentioned in particular:

the family of filamentous fungi:
Genus Penicillium, and in particular P. candidum, P. chrysogenum, P. roquefortii and P. nalgiovensis.

According to a preferred embodiment of the invention, a cellular suspension is preferably used which contains a mixture of several of the microorganisms defined above and which then constitutes a bouquet. Such bouqet of microorganisms are described in particular in patent application FR-A-2 761 237.

These microorganisms are preferably used in the form of a biomass obtained by fermentation and which may be concentrated after centrifugation, microfiltration or any other method known to persons skilled in the art.

In the microbial suspension used according to the method in accordance with the invention, the concentration of bacteria is preferably between about 10¹¹ and 5×10¹¹ cells per ml of suspension, the concentration of yeasts is preferably between about 10¹⁰ and 5×10¹¹ cells per ml of suspension and the concentration of molds is preferably between about 10⁸ and 5×10⁹ cells per ml of suspension.

The cell weakening step is preferably carried out on fresh microbial suspensions or on microbial suspensions which have been subjected to a freezing step.

According to a first particularly advantageous embodiment of the method in accordance with the invention, the weakening step is carried out by an osmotic shock caused by adding a saturated salt solution to said microbial suspension, for example a solution saturated with sodium chloride (at about 360 g/l).

The osmotic shock is preferably performed at a temperature of between about 5 and 9° C.

Optionally, the osmotic shock weakening step may be preceded by a step of dilution of the microbial suspension with the aid of an isotonic salt solution, preferably a sodium chloride solution (at about 9 g/l), at a temperature of preferably between about 5 and 9° C.

By way of example, the weakening of the microorganisms by osmotic shock is carried out by:
adding from about 5 to 35 ml, preferably from about 10 to 30 ml, of the microbial suspension to a quantity of between about 100 and 250 g, preferably between about 150 and 200 g, of an isotonic solution of sodium chloride, and then

adding to the dilution thus obtained a saturated sodium chloride solution in a quantity of between about 250 and 400 g, preferably between 300 and 350 g.

According to a variant of this first embodiment of the method in accordance with the invention, this osmotic shock cell weakening step is combined with an additional heat shock weakening step.

This heat shock weakening step may be carried out before, together with or after the osmotic shock weakening step.

According to a particularly preferred embodiment, said heat shock weakening step is carried out before the osmotic shock weakening step, between the dilution step and the actual osmotic shock weakening step.

In this case, the additional heat shock weakening step is carried out by keeping the dilution of microorganisms at a temperature of between about 45 and 55° C., preferably between about 48 and 52° C., for a period of between about 35 and 85 min, preferably between about 50 and 70 min.

By way of example, the weakening of microorganisms by osmotic shock combined with a heat shock is carried out by:

adding from about 5 to 35 ml, preferably from about 10 to 30 ml of the microbial suspension to a quantity of between about 100 and 250 g, preferably between about 150 and 200 g, of an isotonic sodium chloride solution heated beforehand to a temperature of between about 45 and 59° C., preferably between about 50 and 54° C.,

maintaining the dilution thus obtained at a temperature of between about 45 and 55° C., preferably between about 48 and 52° C. for about 40 to 75 min, preferably for about 50 to 65 min,

cooling the dilution to a temperature of between about 5 and 90C, preferably between about 6 and 8° C., and then

adding to said dilution a saturated sodium chloride salt solution (360 g/l) in a quantity of between about 250 and 400 g, preferably between about 300 and 350 g, at a temperature of between about 5 and 9° C., preferably between about 6 and 8° C.

According to another variant of this particular embodiment of the method in accordance with the invention, the step of weakening by osmotic shock combined with a thermal shock may also be carried out by:

adding from about 2 to 18 ml, preferably from about 5 to 15 ml of the microbial suspension to a quantity of between about 50 and 125 g, preferably between about 75 and 100 g, of an isotonic sodium chloride solution heated beforehand to a temperature of between about 45 and 59° C., preferably between about 50 and 54° C.,

maintaining the dilution thus obtained at a temperature of between about 45 and 55° C., preferably between about 48 and 52° C. for a period of between about 35 to 85 min, preferably between about 50 and 70 min,

cooling the dilution to a temperature of between about 5 and 9° C., preferably between about 6 and 8° C., and then

adding to said dilution a saturated sodium chloride salt solution (360 g/l) in a quantity of between about 125 and 200 g, preferably between about 150 and 175 g, at a temperature of between about 5 and 9° C., preferably between about 6 and 8° C.

According to a second particularly advantageous embodiment of the method in accordance with the invention, the weakening step is carried out by a high pressure shock consisting in subjecting the microbial suspension to a pressure greater than about 1000 bar for a period varying between about 5 and 25 minutes.

By way of example, the high pressure shock weakening step consists in placing from about 5 to 35 ml, preferably from about 10 to 30 ml of microbial suspension in an isostatic high pressure chamber (ACB), and then in subjecting said suspension to a pressure of between about 1000 and 10 000 bar, preferably between about 3000 and 5000 bar, for a period varying between about 5 and 25 minutes, preferably between 10 and 20 minutes.

According to a particular embodiment of the invention, and when the microbial suspension contains yeasts such as for example yeasts belonging to the genus Geotrichum, and in particular G. candidum, then the cell weakening step is carried out solely by osmotic shock, as described above.

According to another particular embodiment of the invention, and when the microbial suspension contains Gram-positive bacteria such as bacteria belonging to the genus Brevibacterium, and in particular B. linens or from yeasts belonging to the genus Debaryomyces, and in particular D. hansenii, then the cell weakening step is carried out by osmotic shock combined with a heat shock, as described above.

When the cell weakening step is complete, the microbial suspensions thus weakened may then be used directly for ripening dairy products.

The subject of the invention is therefore also the use of a cellular microbial suspension weakened by osmotic shock or by high pressure shock, in which the number of cells is from 10 to 10 000 times as high as that of the same microorganism naturally present in the starting raw material to be ripened, in a method for preparing fermented dairy products involving a ripening step, in order to accelerate said ripening phase and to improve the final organoleptic properties of the fermented dairy products thus obtained.

In addition to the preceding arrangements, the invention further comprises other arrangements which will emerge from the description which follows, which refers to an example of preparation of a cellular microbial suspension weakened according to the method in accordance with the invention and to an example relating to a study of the organoleptic properties of cheeses after ripening using said suspensions compared with those of cheeses ripened with cellular suspensions of nonweakened microorganisms, and appended figures in which:

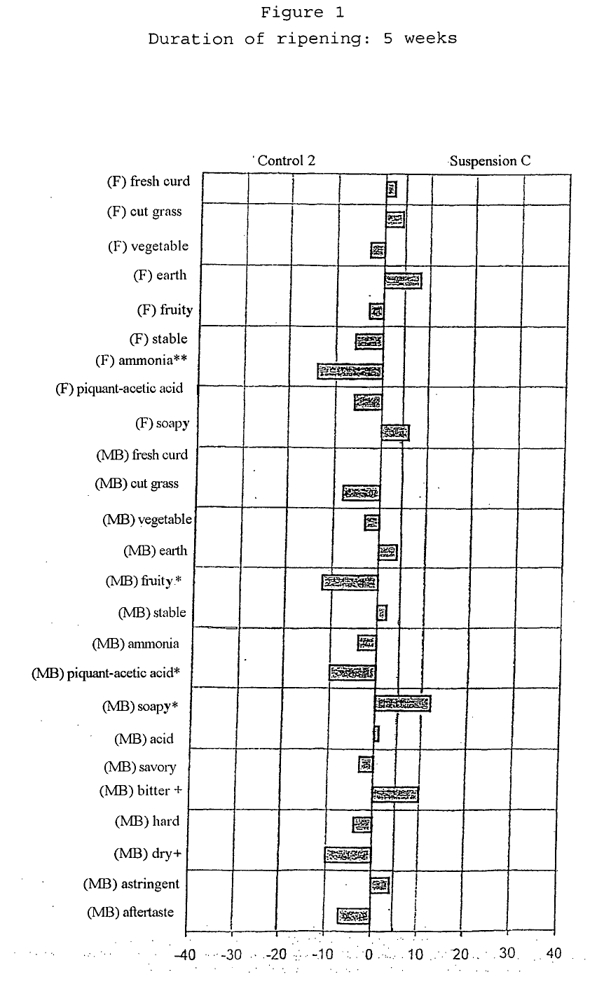

FIG. 1 represents the comparison of the organoleptic properties of two cheeses after 5 weeks of ripening, one ripened with a suspension of nonweakened microorganisms (Control 2: C2), the other ripened with a suspension C of microorganisms weakened by a high pressure shock in accordance with the method according to the invention;

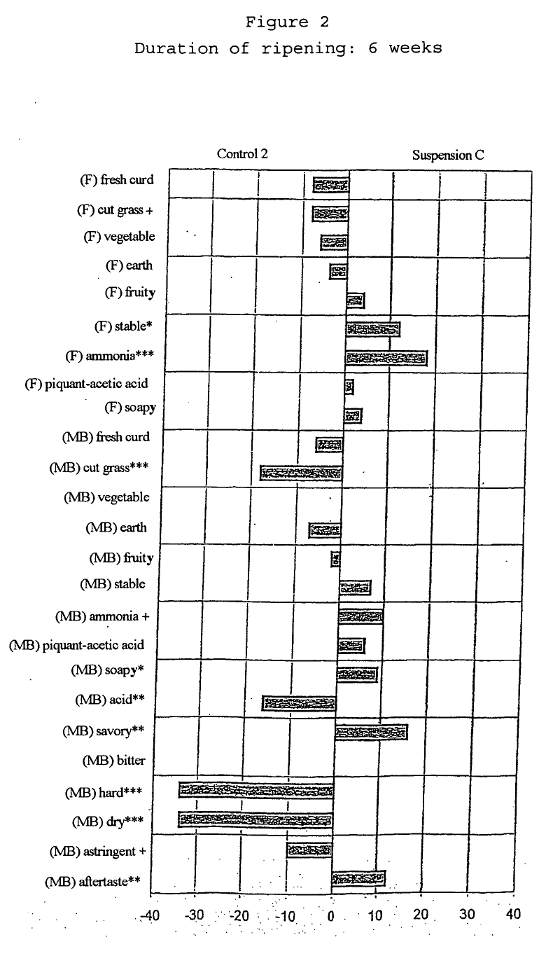

FIG. 2 represents the comparison of the organoleptic properties of two cheeses after 6 weeks of ripening, one ripened with a suspension of nonweakened microorganisms (Control 2: C2), the other ripened with a suspension C of microorganisms weakened by a high pressure shock in accordance with the method according to the invention.

It should of course be understood however that these examples are given solely by a way of illustration of the subject of the invention and do not constitute in any manner a limitation thereto.

### EXAMPLE 1

### Preparation of Cellular Suspensions of Microorganisms Weakened According to the Method in Accordance with the Invention

1) Materials and Methods

a) Microorganisms Used

The microorganisms used in this example are Gram-positive bacteria Brevibacterium linens (sold under the reference BLO (orange) by the company DEGUSSA SAS) provided in the form of a frozen concentrated suspension containing 5×10¹¹ bacteria/ml.

b) Weakening Step Combining Osmotic Shock and Heat Shock

180 g of a sodium chloride solution at 9 g/l are heated to a temperature of 52° C. 20 ml of the concentrated suspension of Brevibacterium linens are then added to this solution. The mixture is kept at a temperature of 50° C. for one hour in a water bath.

The mixture is then cooled to a temperature of 7-8° C., and then 326 g of a saturated sodium chloride solution at 360 g/l are then added thereto. A weakened cellular suspension A is obtained.

The same type of treatment is applied to 10 ml of concentrated Brevibacterium linens suspension, reducing the quantities of sodium chloride solution at 9 g/l and of saturated sodium chloride solution at 360 g/l used by two. A weakened cellular suspension B is obtained.

The suspensions A and B are ready for use for ripening dairy products.

c) Step of Weakening by High Pressure Shock

20 ml of the concentrated Brevibacterium linens suspension are placed in an isostatic high pressure chamber (ACB) for 15 minutes at 4000 bar. A weakened cellular suspension C is obtained which is ready for use for ripening dairy products.

### EXAMPLE 2

### Comparative Sensory Study of the Organo-Leptic Properties of Cheeses Ripened with Suspensions A, B or C

1) Materials and Methods

a) Ripening Phase

The suspensions A, B and C as prepared above were used for the preparation of a Morbier-type cheese.

To do this, tanks containing 800 liters of milk are inoculated, before renneting, with the cellular suspensions A (20 ml), B (10 ml) and C (20 ml).

By way of comparison, two tanks of 800 liters of milk were also inoculated with 20 ml and 10 ml of Brevibacterium linens suspension, respectively, diluted in the same proportions as the suspensions A and B but not weakened (Controls 1 and 2: C1 and C2).

The ripening phase was then carried out at a temperature of 14-15° C. for a period of four to seven weeks.

b) Sensory Evaluation of the Cheeses

The 5 cheeses obtained from the addition of the cellular suspensions A, B and C weakened according to the method in accordance with the present invention and the controls 1 and 2 were subjected to sensory evaluations by a panel of 11 people (smelling, placing in the mouth) during their maturation (at 4, 5, 6 and 7 weeks) in order to evaluate their organoleptic properties.

The evaluations were carried out on 4 pairs of samples from the 5 cheeses available after 4, 5, 6 and 7 weeks of ripening. Each sample consists of a rectangular slice of cheese 5 cm in length and 2 cm wide and 0.5 cm thick, deposited in a plastic dish which is not covered.

The tests are carried out according to a statistical protocol, termed difference test or triangular test, defined in a laboratory in order to examine if significant differences exist between the pairs. The results are expressed as number of correct responses obtained for 66 triangular tests:

if no difference exists between the products, the number of correct responses expected under the effect of chance is equal to 22 (66×⅓);

if the number of correct responses observed is greater than 22, a table makes it possible to determine if this number can be indeed considered as being greater, from a statistical point of view, by chance. In this case, the sample is judged to be statistically different from the control (for a risk equal to 5%) if the value of the number is greater than or equal to 29. These responses are accompanied by an asterisk (see table II below).

A profile test was also carried out in order to compare the organoleptic properties of the cheeses ripened either with the control suspension C2, or with the suspension C in accordance with the invention, after 5 and 6 weeks of ripening.

The profile test is a paired test in which each member of the panel receives two cheese samples and has to determine which, of these two samples, is the one which
1—the most fresh curd
2—the most cut grass
3—the most vegetable
4—the most earth
5—the most fruity
6—the most stable
7—the most ammonia
8—the most piquant/
9—the most soapy
10—the most acid
11—the most savory
12—the hardest
13—the most bitter
14—the driest
15—the most astringent
16—the most persistent acetic acid as regards its after-taste;
   the first nine parameters being evaluated by smelling (F) and after placing in the mouth (MB); the last seven parameters being evaluated only after placing in the mouth (MB).

The differential profile for each pair was performed on 40 tests by smelling and 40 tests after placing in the mouth. All the observations were collected with the aid of the Fizz® acquisition software (Biosystème, 21 560 COURTENON, France).

2) Results

a) Triangular Test

The results obtained are assembled in table II below:

TABLE II

| | | | | | Placing in the | | | |
|---|---|---|---|---|---|---|---|---|
| Duration of ripening | Smelling | | | | mouth | | | |
| (in weeks) | 4 | 5 | 6 | 7 | 4 | 5 | 6 | 7 |
| C1/A | 25 | 20 | 19 | 23 | 25 | 26 | 18 | 26 |
| C2/B | 24 | 24 | 26 | 28 | 26 | 28 | 22 | 29* |
| C2/C | 28 | 34* | nd | 28 | 30* | 30* | nd | 26 |
| C1/C2 | 27 | 25 | 27 | 27 | 26 | 23 | 27 | 23 |

nd: not determined

These results show that the differences between a cheese ripened with a suspension of nonweakened microorganisms (Control 2: C2) and a cheese ripened with a microbial suspension weakened in accordance with the method in accordance with the invention (suspension C) are significant during placing in the mouth after 4 weeks of ripening, and during smelling and placing in the mouth after 5 weeks of ripening. It appears that the differences decrease after 6 weeks of ripening since the differences are no longer significant at 7 weeks of ripening. The differences between a cheese ripened with a suspension of nonweakened microorganisms (Control 2: C2) and a ripened cheese and a cheese ripened with a microbial suspension weakened in accordance with the method in accordance with a invention (suspension B) are significant during placing in the mouth after 7 weeks of ripening.

These results therefore show that organoleptic properties equivalent to 7 weeks of ripening during a traditional ripening method, that is to say not using weakened microorganisms, are obtained after 4 to 5 weeks of ripening after the addition to the raw material to be ripened of suspensions weakened according to the present invention, which has as an advantage a notable reduction in the production costs.

b) Profile Test

The results are given in the accompanying FIGS. 1 and 2 which represent the comparative graphs of the organoleptic properties of two cheeses after 5 and 6 weeks of ripening, one ripened with a suspension of nonweakened microorganisms (Control 2: C2), the other ripened with a suspension C of microorganisms weakened by a high pressure shock in accordance with the method according to the invention.

On these graphs, a difference situated to the left of the middle line means that, for the tester, the number of “control” citations is higher than the number of “trial” citations and conversely.

After five weeks of ripening, these results show that the cheese ripened with the control cellular suspension has a more pronounced aqueous ammonia odor and a more fruity and more piquant taste than the cheese ripened with the cellular suspension C in accordance with the invention. Conversely, the latter has a more pronounced soapy taste than the control.

After six weeks of ripening, the three descriptors “fruity”, “piquant” and “soapy” are no longer significant and, while the descriptor “ammonia” remains significant, the direction is opposite to that observed after 5 weeks of ripening.

On the other hand, the differences between the two cheeses are more marked after 6 weeks of ripening than after 5 weeks of ripening:

a visual comparison of the graphs shows that the segments are, as a whole, longer in length after 6 weeks than after 5 weeks of ripening;

nine descriptors are significant after 6 weeks of ripening against four after 5 weeks. The control cheese is more “cut grass”, more acid, harder and drier than the cheese which was ripened in the presence of the cellular suspension C in accordance with the invention which is, for its part, more “stable”, more ammonia, more savory and has a more intense aftertaste.

Consequently, these results as a whole show that the use of a microbial suspension weakened according to the method in accordance with the invention during ripening of the dairy products makes it possible to improve the organoleptic properties of the products obtained at the end of the ripening phase.

### EXAMPLE 3

### Comparative Assay of the Free Amino Acids and of the Free Fatty Acids in Cheeses Ripened with Suspension of B. linens Weakened According to Various Methods

The aim of this example is to compare the effects of various modes of weakening of a suspension of B. linens bacteria on the quantity of free amino acids (markers of the level of proteolysis-peptidolysis) and of free fatty acids (released during lypolysis) in a Morbier-type cheese after 5, 6 and 7 weeks of ripening.

The quantities of free amino acids and of free fatty acids are proportional to the quantities of enzymes released into the ripening medium after weakening of the bacteria and therefore make it possible to evaluate the efficacy of the weakening treatments used.

1) Materials and Methods

a) Microorganisms Used

In this example, the Gram-positive bacteria Brevibacterium linens as described above in example 1 are used, which are subjected to a weakening step combining osmotic shock and heat shock as described above in example 1, step b). A weakened cellular suspension A is therefore obtained in accordance with the invention which is ready for use.

By way of comparison, four other cellular suspensions of B. linens weakened according to methods described in the prior art and not forming part of the present invention are prepared:

cellular suspension TC: the frozen concentrated suspension containing 5×10¹¹ bacteria/ml is weakened by heat treatment according to the method described by Thiboutot H. et al., Milchwissenschaft, 1995, 50, 448-452, by exposure for 15 seconds to a temperature of 50° C.;

cellular suspension TF: the frozen concentrated suspension containing 5×10¹¹ bacteria/ml is weakened by cold treatment according to the method described by Madkor et al, (cited above), that is to say by freezing the suspension at a temperature of −20° C. for 24 hours, and then thawing on a thermostatted water bath at 40° C., for 10 minutes, before use;

cellular suspension SD: the frozen concentrated suspension containing 5×10¹¹ bacteria/ml is weakened by spray-drying treatment according to the method described by Madkor et al, (cited above), by drying at 190° C. the suspension brought to 16-18% of dry extract, heated beforehand at 38° C.,

suspension L: frozen concentrated suspension containing 5×10¹¹ bacteria/ml is weakened by freeze-drying treatment according to the method described by Johnson J. A. C. et al., J. Dairy Sci., 1995, 78, 761.

The weakened cellular suspensions A, TC, TF, SD and L, and a nonweakened cellular suspension of B. linens (control) are then used to prepare a Morbier-type cheese according to the ripening method described above in example 2.

After 5, 6 and 7 weeks of ripening, samples of each of the cheeses ripened with the cellular suspensions A, TC, TF, SD and L so as to carry out the assaying of the free amino acids and of the free fatty acids according to the methods described by Madkor et al., (cited above).

The results obtained on each of the samples are presented in table III below:

TABLE III

| | Assay of the free amino | | | Assay of the free fatty | | |
|---|---|---|---|---|---|---|
| | acids (in mg of | | | acids (in m.equiv./g | | |
| | leucine/g of cheese) | | | of cheese) | | |
| Weakened | Duration of ripening | | | Duration of ripening | | |
| cellular | (weeks) | | | (weeks) | | |
| suspensions | 5 | 6 | 7 | 5 | 6 | 7 |
| A | 4 | 4.2 | 4.5 | 3.1 | 3.4 | 3.9 |
| TC* | 1.4 | 1.6 | 1.9 | 1.1 | 1.3 | 1.7 |
| TF* | 1.1 | 1.3 | 1.5 | 0.8 | 1.0 | 1.4 |
| SD* | 0.8 | 0.9 | 1.1 | 0.8 | 1.0 | 1.2 |
| L* | 0.6 | 0.6 | 0.7 | 0.6 | 0.8 | 0.9 |
| Control | 0.6 | 0.7 | 0.8 | 0.7 | 0.7 | 0.9 |

*comparative weakened cellular suspensions not forming part of the invention.

B. linens is a bacterium whose wall is very resistant. It is in particular known for its salt tolerance, a sign of a good overall resistance.

These results show that the bacterium B. linens withstands better the different weakening treatments described in the prior art (TF, TC, SD and L), in particular in the articles by Madkor et al. and Johnson J. A. C. et al. (cited above) than bacteria which were subjected to a weakening treatment in accordance with the invention (A). It is probable that the number of bacteria which are still viable, that is to say whose wall has not been sufficiently weakened in order to release the enzymes responsible for ripening, is still too high in the case of the suspensions TF, TC, SD and L of the prior art. This high residual viability in the suspensions TF, TC, SD and L runs counter to the objective of the present invention, and demonstrates that the weakening methods described in the prior art do not make it possible to weaken the microorganisms effectively so as to allow the rapid and nevertheless controlled release of their cellular content as is the case for the weakened cellular suspension A in accordance with the invention.

1. A method for manufacturing a fermented dairy product comprising a step of ripening by means of a suspension of ripening microorganisms in which the number of cells constituting said suspension is 10 to 10 000 times as high as that of the same microorganism naturally present in the starting raw material to be ripened, characterized in that it comprises, before bringing said suspension into contact with the raw material, at least one preliminary step of cell weakening of said microorganisms by means of an osmotic shock or a high-pressure shock.

2. The method as claimed in claim 1, characterized in that the microorganisms are chosen from:
Gram-positive bacteria among which there may be mentioned in particular:
the Corynebacteriaceae family:
Genus Corynebacterium, and in particular C. glutamicum,
Genus Brevibacterium, and in particular B. linens,
Genus Arthrobacter, and in particular A. globiformis,
Genus Propionobacterium,
the Micrococaceae family:
Genus Micrococcus,
Genus Staphylococcus, and in particular S. xilosus and S. carnosus,
Gram-negative bacteria among which there may be mentioned in particular:
the Enterobacteriaceae family:
Genus Hafnia, and in particular H. alvei,
Genus Enterococcus, and in particular E. faecalis and E faecium.
The yeasts among which there may be mentioned in particular:
Genus Debaryomyces, and in particular D. hansenii,
Genus Saccharomyces, and in particular S. cerevisiae,
Genus Kluyveromyces, and in particular K. lactis,
Genus Geotrichum, and in particular G. candidum.
Molds among which there may be mentioned in particular:
the family of filamentous fungi:
Genus Penicillium, and in particular P. candidum, P. chrysogenum, P. roquefortii and P. nalgiovensis.

3. The method as claimed in claim 2, characterized in that the cellular suspension contains a mixture of several of the microorganisms defined in claim 2.

4. The method as claimed in any one of the preceding claims, characterized in that the concentration of bacteria is between 10¹¹ and 5×10¹¹ cells per ml of suspension, the concentration of yeasts is between 10¹⁰ and 5×10¹¹ cells per ml of suspension and the concentration of molds is between 10⁸ and 5×10⁹ cells per ml of suspension.

5. The method as claimed in any one of the preceding claims, characterized in that the weakening step is carried out by an osmotic shock caused by adding a saturated salt solution to said microbial suspension.

6. The method as claimed in claim 5, characterized in that the saturated salt solution is a sodium chloride solution.

7. The method as claimed in any one of the preceding claims, characterized in that the osmotic shock is performed at a temperature of between 5 and 9° C.

8. The method as claimed in any one of the preceding claims, characterized in that the osmotic shock weakening step is preceded by a step of dilution of the microbial suspension with the aid of an isotonic salt solution.

9. The method as claimed in claim 8, characterized in that the isotonic salt solution is a sodium chloride solution.

10. The method as claimed in any one of the preceding claims, characterized in that the osmotic shock cell weakening step is combined with an additional heat shock weakening step.

11. The method as claimed in any one of claims 8 to 10, characterized in that the heat shock weakening step is carried out before the osmotic shock weakening step, between the dilution step and the actual osmotic shock weakening step.

12. The method as claimed in claim 10 or 11, characterized in that the additional heat shock weakening step is carried out by keeping the dilution of microorganisms at a temperature of between 45 and 55° C. for a period of between 35 and 85 min.

13. The method as claimed in any one of claims 1 to 4, characterized in that the weakening step is carried out by a high pressure shock consisting in subjecting the microbial suspension to a pressure greater than 1000 bar for a period varying between 5 and 25 minutes.

14. The method as claimed in any one of claims 1 to 9, characterized in that the microbial suspension contains yeasts and in that the cell weakening step is carried out solely by osmotic shock.

15. The method as claimed in any one of claims 1 to 12, characterized in that the microbial suspension contains Gram-positive bacteria and in that the cell weakening step is carried out by osmotic shock combined with a heat shock.

16. The use of a cellular microbial suspension weakened by osmotic shock or by high pressure shock, in which the number of cells is from 10 to 10 000 times as high as that of the same microorganism naturally present in the starting raw material to be ripened, in a method for preparing fermented dairy products involving a ripening step, in order to accelerate said ripening phase and to improve the final organoleptic properties of the fermented dairy products thus obtained.
